(19) United States
(12) Patent Application Publication
(10) Pub. No.: US 2026/0201729 A1
(43) Pub. Date: Jul. 16, 2026

(54) WIRE WINDING FENCING ATTACHMENT FOR A HAND HELD POWER TOOL

(71) Applicant: WIREMAN PTY LIMITED, Milsons Point NSW (AU)

(72) Inventor: Ian LOWREY, Milsons Point NSW (AU)

(21) Appl. No.: 19/440,725

(22) Filed: Jan. 6, 2026

(30) Foreign Application Priority Data
Jan. 10, 2025 (AU) 2025 900 056
Feb. 9, 2025 (AU) 2025 900 341

(51) Int. Cl. E04H 17/26; B23B 45/00

(52) U.S. Cl. CPC E04H 17/266; B23B 45/003

(57) ABSTRACT

A wire winding fencing attachment (6) for a handheld power tool (1) is disclosed. The attachment takes the form of a housing (8) having a mouth. An engagement means (7,107) is associated with the housing to permit both the housing to be engaged with the power tool and a drive input (17) of the attachment to be rotatably coupled to the power outlet. A geartrain (15) powers a rotor (16) which is rotatably mounted facing the mouth. A single winding arm (11) is mounted exterior of the housing, being rotatable with the rotor, and carrying a sheave (74) rotatably mounted on the winding arm at a location radially spaced from the rotor axis of rotation. The winding arm (11) is rotatably mounted relative to the housing and movable between a first position on one side of the housing and a second position on an opposite side of the housing.

### FIELD OF THE INVENTION

The present invention relates to fencing and, in particular, to agricultural fencing which normally incorporates knot tying of fencing wire.

### BACKGROUND ART

International Patent Application No WO2023/035025 to the present applicant discloses a fencing attachment powered by a handheld power tool such as a portable electric drill. The contents of the above-mentioned patent application are incorporated into the present specification for all purposes. The fencing attachment described therein enables the tying of fencing knots to be mechanised. The fencing attachment has a pair of winding arms located one to either side of a central housing. The pair of arms enabled both right and left hand operation of the attachment and also convenient operation irrespective of on which side of the fence the operator was standing. The distance between the winding arms was approximately 90mm (3 ½ inches).

When the above-mentioned fencing attachment was designed, the mesh used in agricultural fences typically consisted of from 7 to 17 horizontal strands and a plurality of vertical pickets which were secured to the horizontal strands and which define a number of generally rectangular openings. These openings are typically 150 mm (approximately 6 inches) in width and 50-125 mm (approximately 2 - 5 inches) in height. Such mesh is often used for exclusion fencing so as to fence in domestic stock and fence out unwanted feral animals and wild animals.

However, in recent years a new mesh for agricultural fences has been developed in which the rectangular openings are much smaller, typically being approximately 50mm (approximately 2 inches) in width. Such meshes are particularly used for horse fencing since the small aperture size makes it less likely that a horse, and a foal in particular, will be injured if it comes into contact with the fence. As a consequence of the reduction in aperture size of the mesh, the above-mentioned fencing attachment is unable to be used on such horse mesh because the “snout” of the attachment is too wide.

### Genesis of the Invention

The Genesis of the present invention is a desire to create a wire winding fencing attachment for a handheld power tool which is able to be used with such horse meshes of narrow aperture width.

### SUMMARY OF THE INVENTION

In accordance with a first aspect of the present invention there is disclosed a wire winding fencing attachment for a handheld power tool having a power outlet, said attachment comprising:

a housing having a mouth,

an engagement means associated with said housing to permit both the housing to be engaged with the power tool and a drive input of the attachment to be rotatably coupled to the power outlet,

a geartrain extending from said drive input to a rotor having an axis of rotation, said rotor being rotatably mounted facing said mouth,

a single winding arm mounted exterior of said housing, being rotatable with said rotor, and carrying a sheave rotatably mounted on said winding arm at a location radially spaced from said axis of rotation,

wherein said winding arm is rotatably mounted relative to said housing and movable between a first position on one side of said housing and a second position on an opposite side of said housing.

Preferably, the geartrain has a driveshaft rotatable by said handheld power tool outlet and a transverse shaft which drives rotation of said rotor, and said transverse shaft is rotatable relative to said driveshaft during movement of said winding arm between said first and second positions.

Preferably, the position of said transverse shaft relative to said driveshaft is substantially the same in each of said winding arm positions.

Preferably, the attachment has a first latch means which retains said winding arm in either said first or said second position.

Preferably, the first latch means is movable by a release actuator attached to said housing and having a release plunger which extends beyond said housing.

Preferably, a resiliently mounted projection interconnects said winding arm and an actuating mechanism including an actuating trigger whereby movement of said actuating trigger moves said winding arm into a wire receiving configuration.

Preferably, said resiliently mounted projection is spring-loaded whereby releasing said actuating trigger moves said winding arm out of said wire receiving configuration and into a wire holding configuration.

Preferably, with said actuating mechanism not actuated, said winding arm is rotatable without engaging said resiliently mounted projection.

### BRIEF DESCRIPTION OF THE DRAWINGS

Embodiments of the present invention will now be described, by way of example only, with reference to the accompanying drawings in which:

FIG. 1 is a perspective view of the fencing attachment of a first embodiment, the view being taken from the left-hand side of the drill and showing the winding arm on the left-hand side (right and left being with respect to the hand of the operator holding the drill),

FIG. 2 is a perspective view from the right-hand side of the fencing attachment of FIG. 1,

FIG. 3 is a perspective view from the left-hand side similar to that of FIG. 1 and permitting easy comparison with FIG. 4,

FIG. 4 is a perspective view from the left-hand side and showing the winding arm being located on the right-hand side,

FIG. 5 is an exploded perspective view of the drill attachment of a second embodiment and excluding the drill itself,

FIG. 6 is a perspective view from the right-hand side and illustrating the interior geartrain of both embodiments with the condition where the winding arm is on the left-hand side of the drill,

FIG. 7 is a perspective view similar to FIG. 6 but showing the condition where the winding arm is on the right-hand side of the drill,

FIG. 8 is an exploded perspective view of the gear train in the condition illustrated in FIG. 6,

FIG. 9 is an exploded perspective view from the right-hand side of a coupling housing,

FIG. 10 is an exploded perspective view from the left-hand side of the winding finger actuator,

FIG. 11 is a perspective view from the right-hand side of the winding finger actuator of FIG. 10,

FIG. 12 is a perspective view from the left-hand side of the winding finger actuator of FIGS. 10 and 11,

FIG. 13 is a perspective view from the right-hand side showing the winding arm about to be moved from the left-hand side to the right-hand side,

FIG. 14 is a perspective view from the left-hand side showing the winding arm moved to the right-hand side,

FIG. 15 is a perspective view from the right-hand side showing the winding arm in operation,

FIG. 16 is a perspective view from the left-hand side showing the first step in wire winding with the winding arm on the left-hand side,

FIG. 17 is a left-hand perspective view similar to FIG. 16 but showing an intermediate step in wire winding,

FIG. 18 is a left-hand perspective view similar to FIGS. 16 and 17 and showing the conclusion of the wire winding,

FIG. 19 is a front perspective view of an attachment of a third embodiment, the drill being illustrated in broken lines,

FIG. 20 is a right side view of the drill and attachment of FIG. 19, the left side view being a mirror image,

FIG. 21 is a perspective view of the trigger mechanism of the drill and attachment of FIG. 19, and

FIG. 22 is an exploded perspective view of the trigger mechanism of FIG. 21.

### DETAILED DESCRIPTION

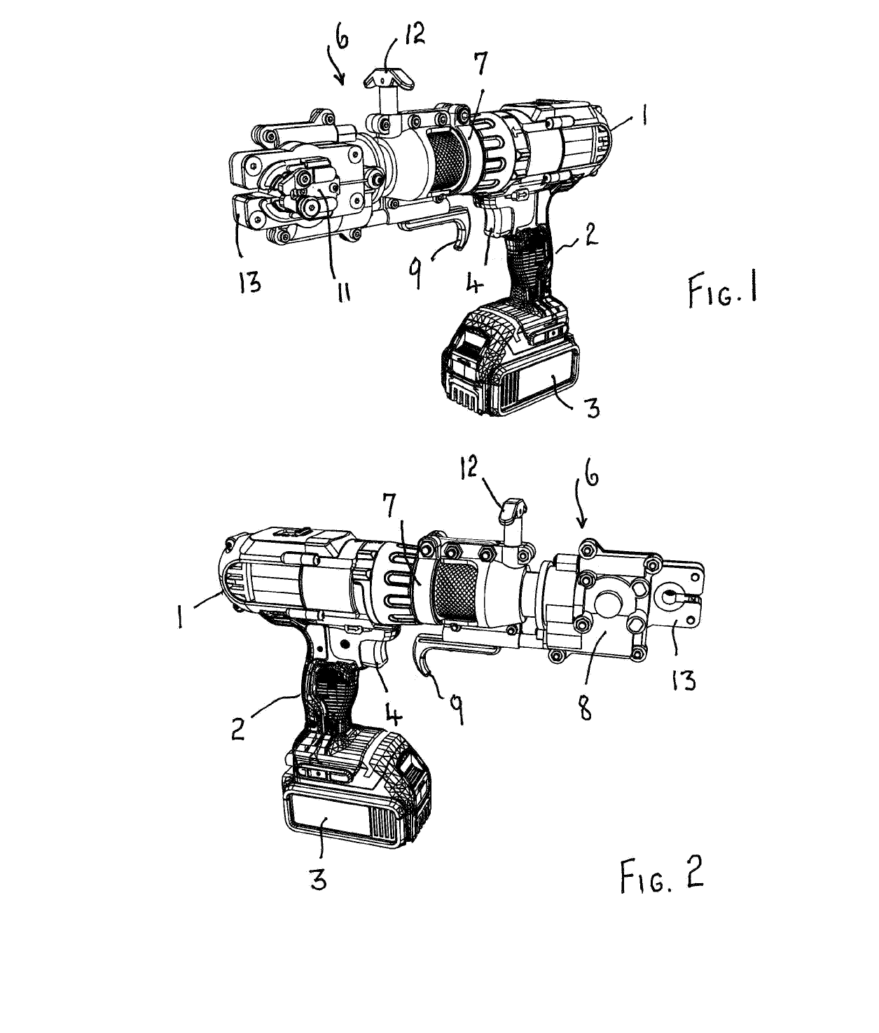

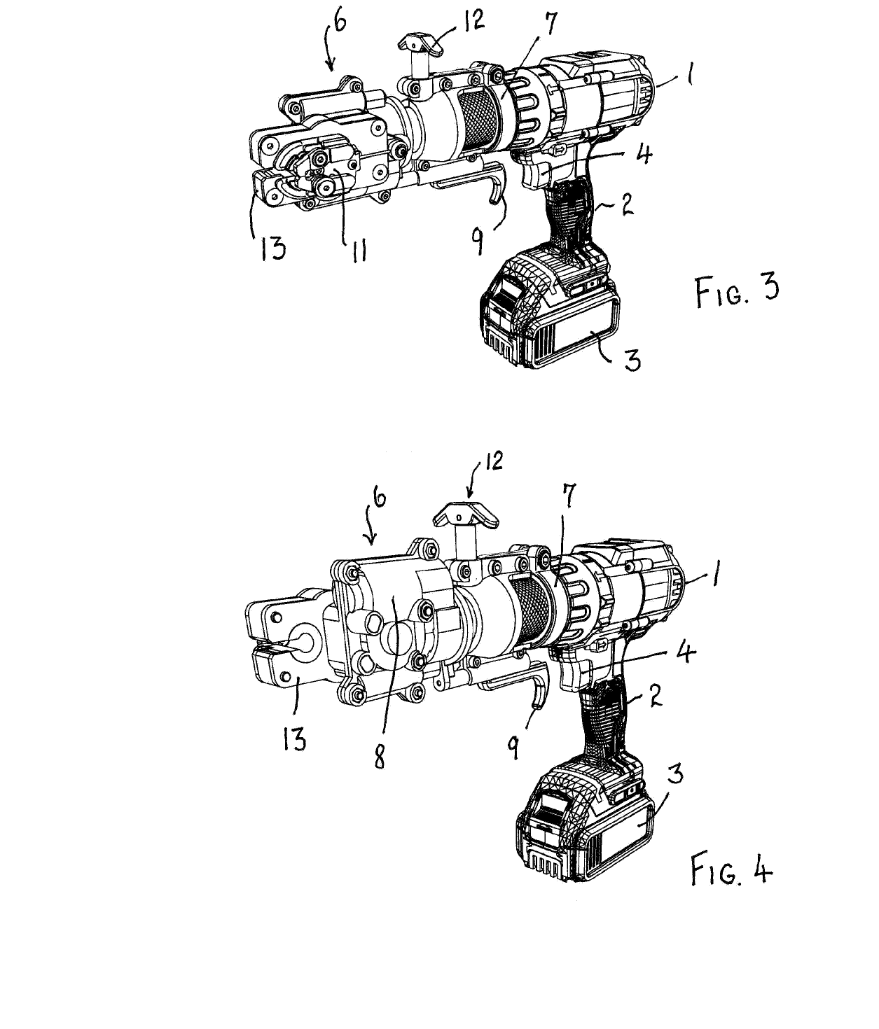

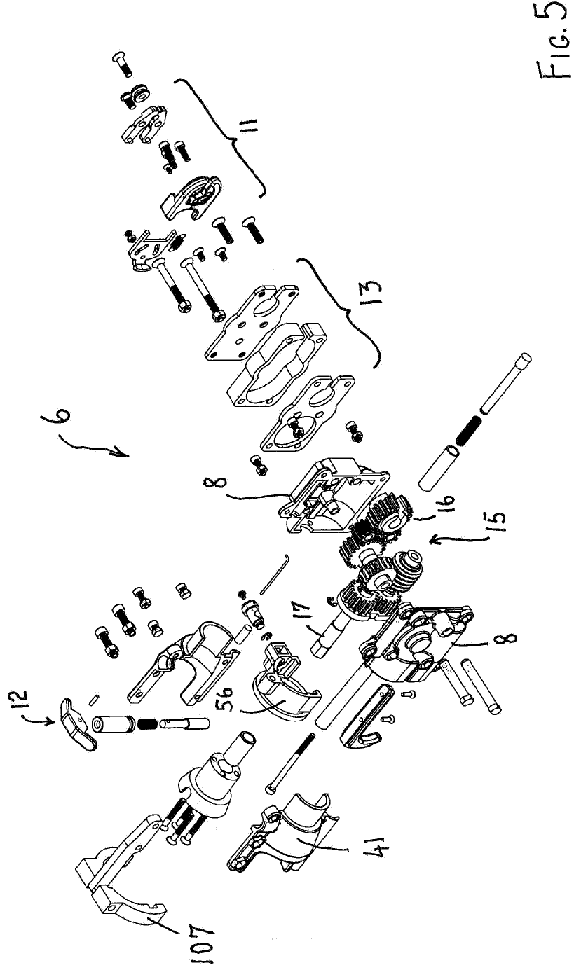

As seen in FIGS. 1-4, a drill 1 has a pistol grip handle 2 and a battery 3. A drill trigger 4 can be operated in known fashion so as to rotate a chuck (partially obscured). A drill attachment 6 of a first embodiment is releasably secured to the drill 1 by means of a circular clamp 7 of the drill attachment 6 which clamps the attachment 6 to a collet of the drill 1. The drill attachment 6 has a housing 8 and an attachment trigger 9 which is positioned in advance of the drill trigger 4. The housing 8 has a single winding arm 11 and, as best seen by a comparison of FIGS. 3 and 4, the winding arm 11 is able to be moved from one side of the housing 8 to the other. This enables knot tying on either side of the aperture in the fencing mesh irrespective of on which side of the fence the operator is standing. As will be explained in greater detail hereafter, the winding arm 11 is latched into either one, or the other, of these positions. The housing 8 includes a switch plunger 12 which releases the latch and permits the movement of the winding arm 11 between its two operating positions.

It will be apparent from FIGS. 1-4 that the “snout” 13 of the drill attachment 6 is narrow and so the snout 13 including the winding arm 11 is able to be inserted into the narrow rectangular openings of the above-described horse mesh. In the initial manufactured prototype, the width of the snout is approximately 30-40mm (1 ½ inches) which is easily accommodated by the above-mentioned horse mesh.

Turning now to FIG. 5, an exploded perspective view of the drill attachment 6 of a second embodiment is illustrated with the winding arm 11 and snout 13 being illustrated on the left-hand side of the drill attachment 6. The first and second embodiments only differ in that the second embodiment has a semicircular clamp 107 rather than the circular clamp 7 of FIGS. 1-4. This difference in the nature of the clamp enables essentially the same attachment 6 to be used with drills made by different manufacturers.

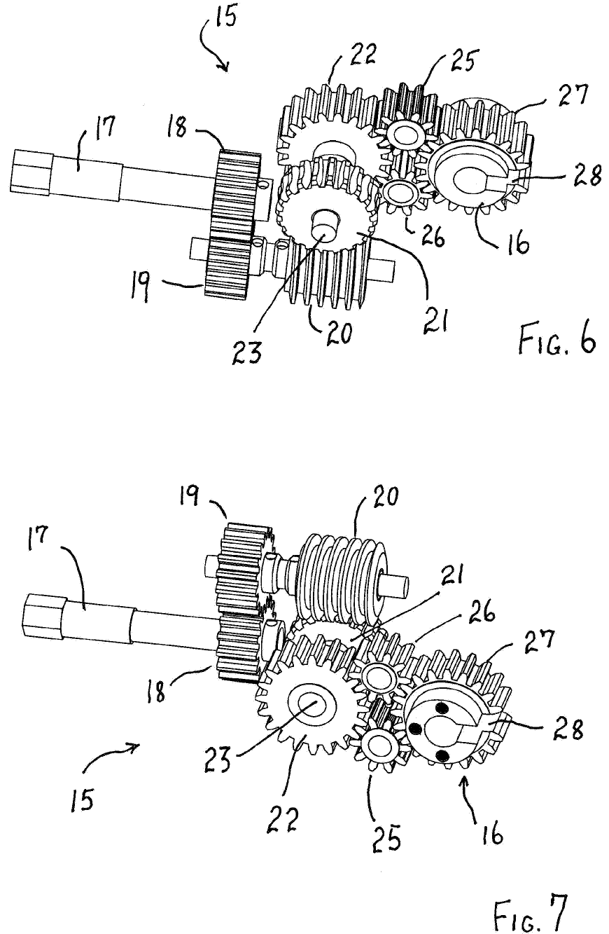

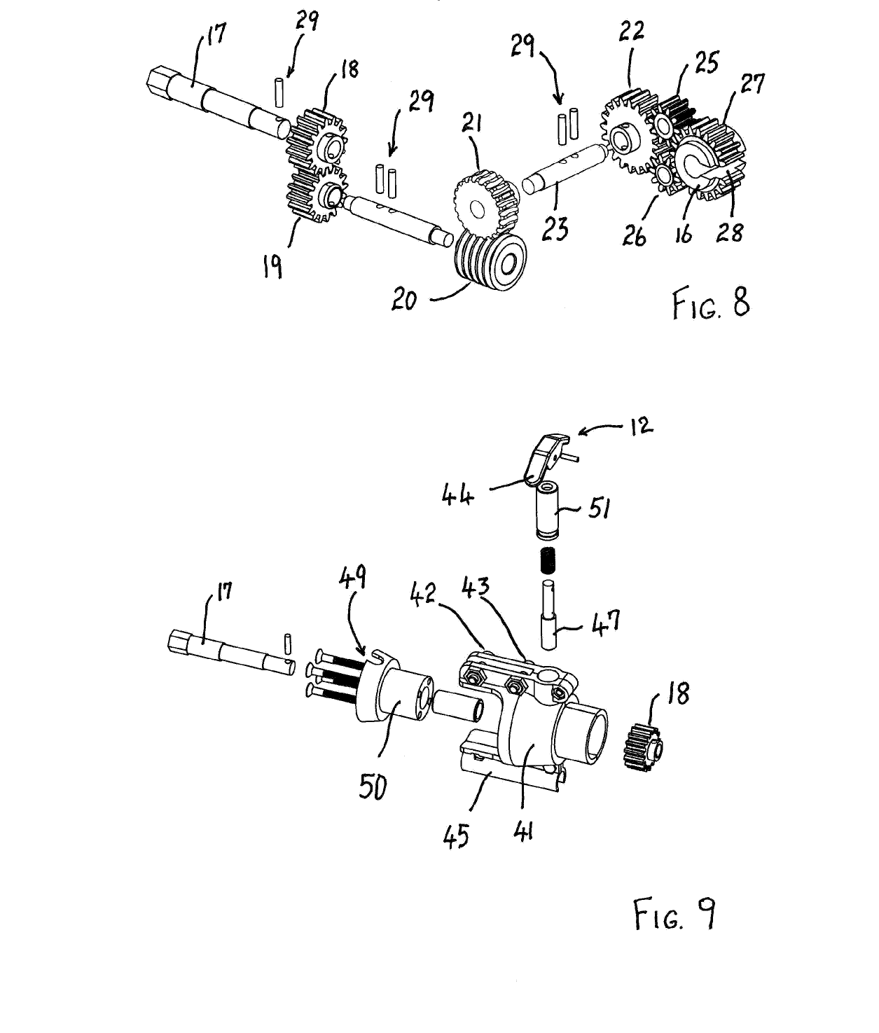

It will be seen that located inside the housing 8 is a geartrain 15 which interconnects the drill 1 and the winding arm 11. The geartrain 15 is illustrated in more detail in FIGS. 6-8 and extends between a slotted rotor 16 and a driveshaft 17 which is able to be interconnected with the conventional chuck of the drill 1. It will be seen that the driveshaft 17 is connected via a pair of spur gears 18, 19 with a worm drive 20. The worm drive 20 is engaged with one gear 21 of a first pair of spaced apart gears 21, 22 which are mounted on a transverse axle 23. The second gear 22 of the pair of gears 21, 22 drives a further pair of gears 25, 26 which are in turn engaged with the exterior teeth 27 on the slotted rotor 16. The presence of the further pair of gears 25, 26 ensures that the rotor 16 is able to be continuously rotated by the second gear 22, notwithstanding the presence of a slot 28 in the slotted rotor 16. As seen in FIG. 8, pins 29 are engaged with corresponding shafts in order to maintain the position of the gears on the shafts.

A particular feature of the geartrain 15 is that the second gear 22, the second pair of gears 25, 26 and the rotor 16 are able to be moved together from one side of the shaft 17 to the other whilst maintaining the one gear 21 engaged with the worm gear 20 and the worm gear generally aligned with the shaft 17. That is, the spur gear 18 functions as a pivot. This feature enables the snout 13 and winding arm 11 to be moved between their two positions as referred to above.

This movement of the geartrain 15 enabling rotation of the rotor 16 is illustrated by comparing FIGS. 6 and 7. It will be seen in FIG. 6 that the worm drive 20 is “below” the driveshaft 17 whereas in FIG. 7 the worm drive 20 is “above” the driveshaft 17. A particularly preferred feature of the geartrain 15 illustrated in FIGS. 6 and 7 is that the size of the spur gears 18, 19, the worm drive 20 and the one gear 21 are selected so that the position of the transverse axle 23 relative to the driveshaft 17 is essentially the same in both positions as illustrated in FIGS. 6 and 7. This very substantially simplifies the arrangements of the attachment trigger 9 and the winding finger actuator mechanism (to be described hereafter) which interconnects the attachment trigger 9 with the winding arm 11.

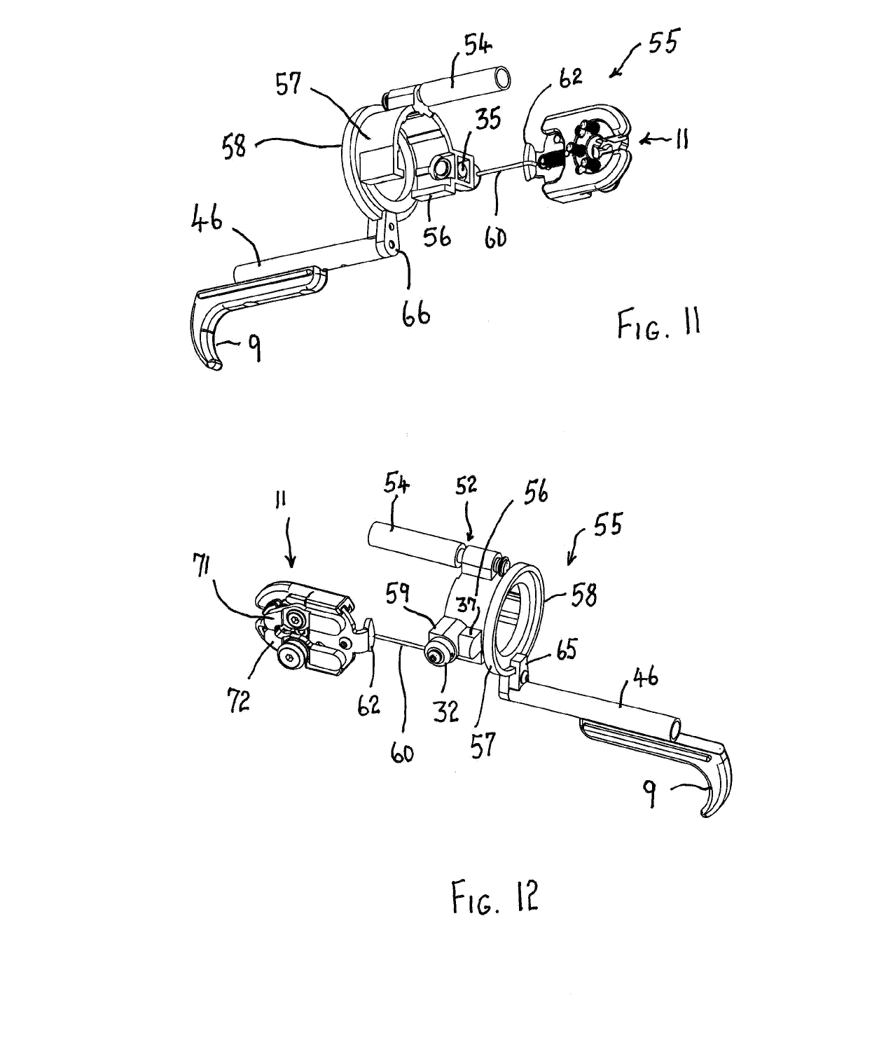

As seen in FIG. 9, a coupling housing 41 is provided to both house the driveshaft 17 and provide an attachment for the semicircular clamp 107 which is used to interconnect the attachment 6 and drill 1. The coupling housing 41 on its upper surface includes a pair of spaced apart bolts 42, 43 which are able to grip either the circular clamp 7 of FIGS. 1-4 or the semicircular clamp 107 of FIG. 5. Depending upon the drill manufacturer, either the clamp 7 or the clamp 107 is used. In addition, the coupling housing 41 on its lower surface includes a semicircular tube 45 which receives a cylindrical trigger tube 46 illustrated in FIGS. 11 and 12.

Also illustrated in FIG. 9 is the switch plunger 12 which is spring-loaded and has a cylindrical projection 47 which mates with either one of two semicircular cut outs 49 in a sleeve 50 which surrounds the driveshaft 17. Only one of the two semicircular cutouts 49 is visible in FIG. 9. The switch plunger 12 has a pivotable cross arm 44 mounted on the upper end of a tube 51 which houses the cylindrical projection 47 and its associated spring. Depressing either end of the cross arm 44 raises the cylindrical projection 47 and permits the sleeve 50 to rotate within the coupling housing 41. This is required to be done for the snout 13 and winding arm 11 to be moved from one side of the drill attachment 6 to the other.

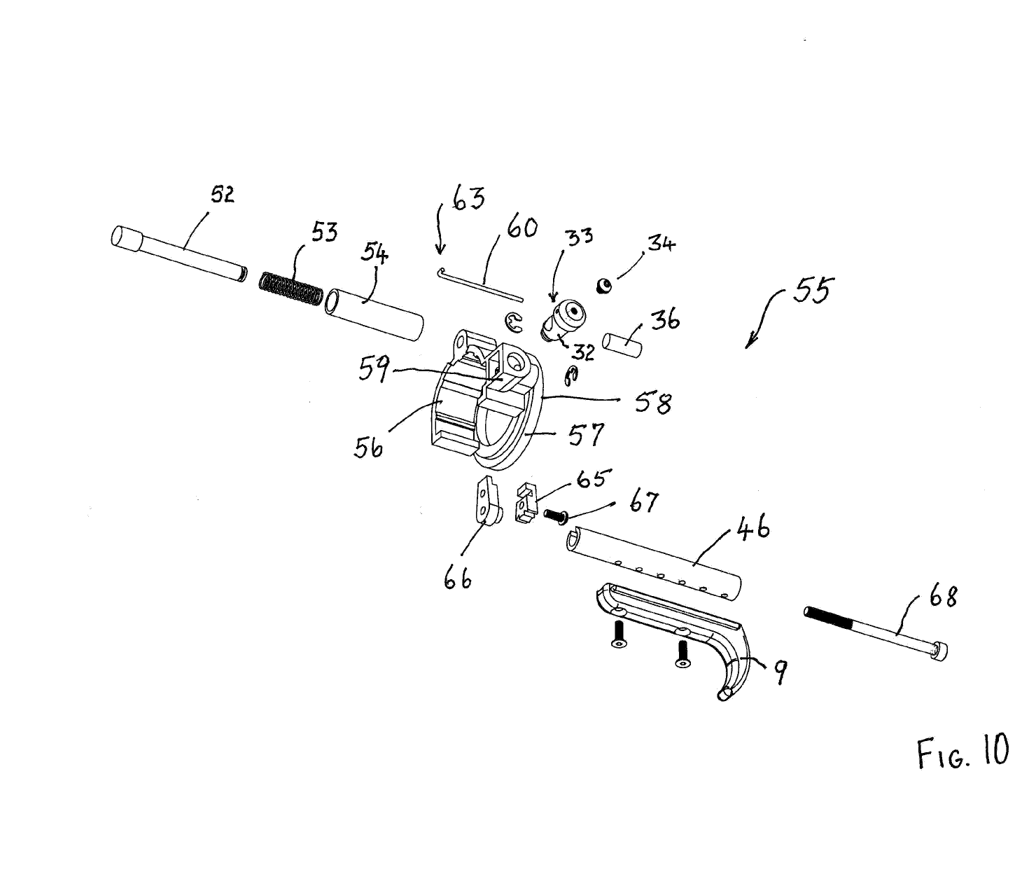

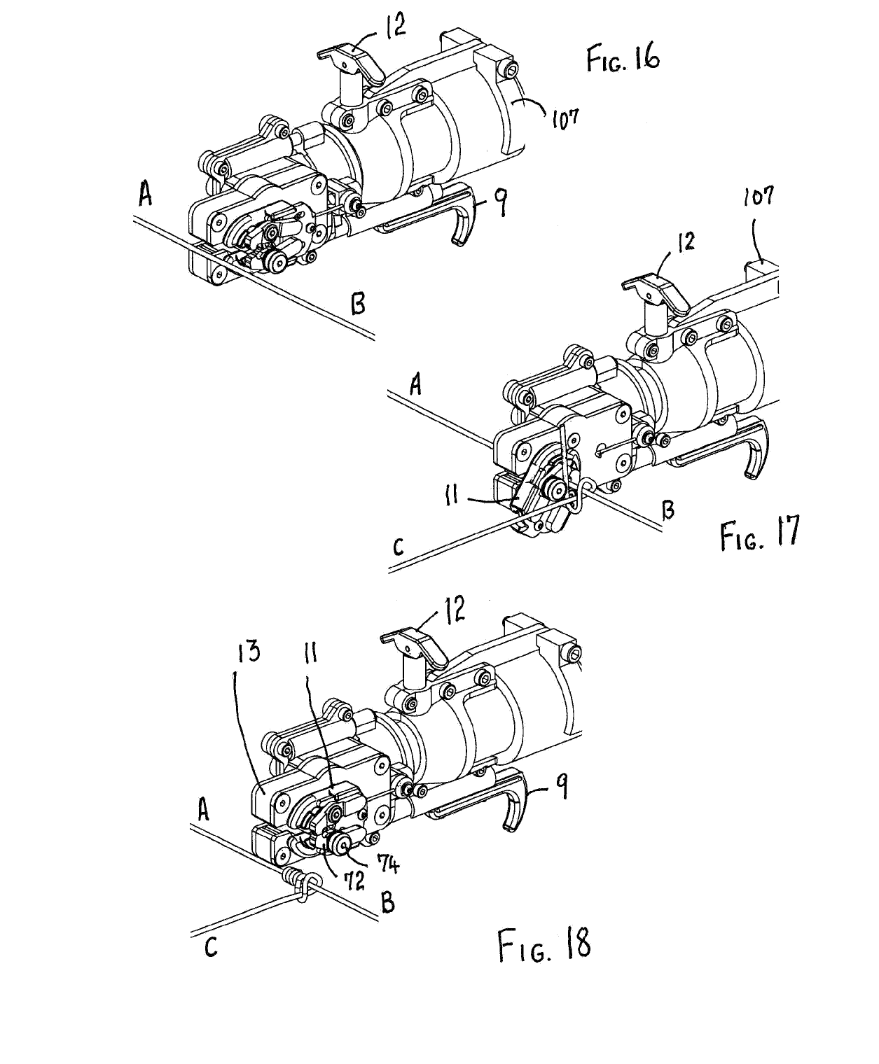

Turning now to FIGS. 10-12, an actuation mechanism 55 operated by the attachment trigger 9 is illustrated. A trigger housing 56 is slidably mounted on the front end of the coupling housing 41 (FIG. 9) and includes a circular ring 57 having a collar 58. On one side of the trigger housing 56 is a boss 59 in which a wire projection 60 is adjustably mounted. As seen in FIGS. 11 and 12, the winding arm 11 (which is described in detail in FIGS. 11-18 of the above-mentioned WO2023/035025) has an L-shaped projection 62 which is capable of engaging with the hooked distal end 63 (FIG. 10) of the wire projection 60.

As seen in FIG. 10, the wire projection 60 is mounted in a bolt 32 which engages with the boss 59 and is retained by a circlip. The head of the bolt 32 has a through hole 33 through which the wire projection 60 passes. A grub screw 34 screws into the head of the bolt 32 thereby clamping the wire projection 60 in the desired position. In the shank of the bolt 32 is a cylindrical passageway 35 (FIG. 11) which receives a rubber cylinder 36. The boss 39 includes a hollow protrusion 37 (FIG. 12) which receives the rubber cylinder 36. As a consequence of this arrangement, the bolt 32 is resiliently mounted in the boss 59.

If it should happen that the wire projection 60 is maladjusted relative to the L-shaped projection 62 of the winding arm 11, then the rotation of the winding arm 11 may mean that the projection 62 clashes with the wire projection 60. In this event, the wire projection 60 resiliently yields to the motion of the winding arm 11 and no damage is caused to the winding arm 11. If necessary, the wire projection 60 can be straightened or replaced after such a collision.

An inner and an outer slotted block 65, 66 are arranged so that their slots are engaged with the collar 56. The slotted blocks 65, 66 are held together by means of a first screw 67 and held to the cylindrical trigger tube 46 by means of a long screw 68 as illustrated in FIG. 10. The attachment trigger 9 is screwed to the cylindrical trigger tube 46 in any one of a number of possible positions. This enables the spacing between the attachment trigger 9 and the drill trigger 4 to be set at a selected one of the number of positions thereby permitting easy adjustment to take up variations in sizes of the drill 1 produced by various manufacturers.

By moving the attachment trigger 9 towards the drill trigger 4, so the trigger housing 56 can be moved to the rear of the drill 1. If the L-shaped projection 62 of the winding arm 11 is not aligned with the wire projection 60, then this movement of the attachment trigger 9 is of no consequence. However, if the L-shaped projection 62 is aligned with the wire projection 60, then the movement of the attachment trigger 9 draws the L-shaped projection 62 rearwardly and thereby opens the fingers 71, 72 of the winding arm 11. This enables a fencing wire to be entered into the slot 28 of the rotor 16.

An important function of the trigger housing 56 is that it rotates with the winding arm 11 around the driveshaft 17. That is, the boss 59 and spring projection 60 are always located on the same side of the drill 1 as is the winding arm 11. Irrespective of which position the trigger housing 56 occupies, the two blocks 65, 66 remain engaged with the collar 58. Thus, moving the attachment trigger 9 rearwardly always also slides the trigger housing 56 rearwardly.

As seen in FIGS. 10-12, the trigger housing 56 includes a bolt 52, a spring 53 and a hollow rod 54. The spring 53 passes over the shank of the bolt 52 and is retained by the head of the bolt 52. The tip of the bolt 52 is engaged with the trigger housing 56 by means of a circlip. When the drill attachment 6 is assembled, the hollow rod 54 is retained within the housing 8. When the attachment trigger 9 is operated, the trigger housing 56 moves rearwardly thereby partially withdrawing the bolt 52 from the hollow rod 54. In this way, the bolt 52 functions as a linear guide to the sliding motion of the trigger housing 56.

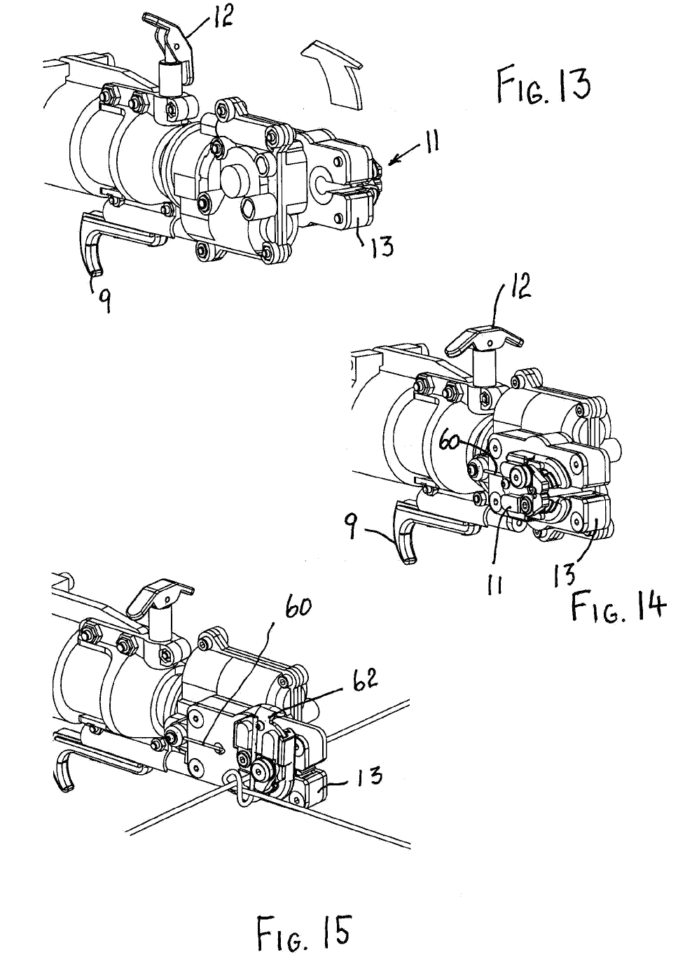

In FIGS. 13 and 14, the movement of the winding arm 11 and snout 13 from one side of the drill to the other is illustrated. As seen in FIG. 13, the cross arm 44 of the switch plunger 12 is depressed to one or the other side, thereby raising the cylindrical projection 47 of FIG. 9 out of one of the semicircular cutouts 49. Then the snout 13 is manually moved in the direction of the arrow illustrated in FIG. 13 so as to rotate both the snout 13 and the trigger housing 56. This rotation continues for 180° at which point the cylindrical projection 47 engages with the other one of the semicircular cut outs 49. This thereby maintains the snout 13 and winding arm 11 in the position illustrated in FIG. 14. In order to move back into the position illustrated in FIG. 13, the above procedure is again carried out, however, the direction of rotation of the snout 13 and winding arm 11 is reversed.

As seen in FIGS. 16-18, the drill trigger 4 is operated so as to rotate the winding arm 11 into the position illustrated in FIG. 16 with the gap between the fingers 71, 72 aligned with the opening in the snout 13. This enables the attachment 6 to be moved towards a length of wire AB. The wire AB is then engaged with the slot 28 in the slotted rotor 16 and trigger 9 actuated so as to open the space between the fingers 71, 72. As a consequence of this action, the wire AB can be fully engaged with the drill attachment 6.

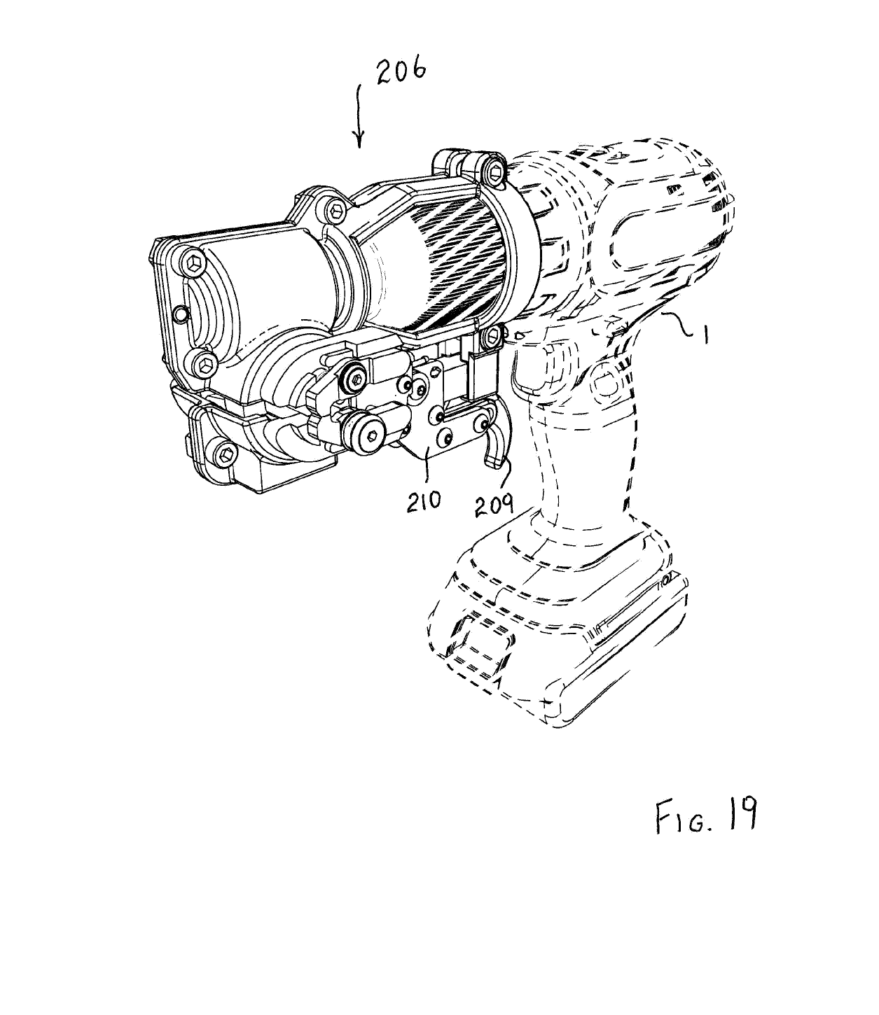

Thereafter, the end B of the wire AB is then wrapped around a post (not illustrated) so that the free end of the wire be becomes the free wire C as illustrated in FIG. 17. This end of the wire is then either manually or mechanically wound so as to commence the production of the termination knot as illustrated in FIG. 17. Thereafter, holding down the drill trigger 4 rotates the winding arm 11 and its sheave 74 which rotates the free end of the wire C around the wire AB. At the completion of this process, if necessary the drill trigger 4 is operated so as to wind the winding arm 11 into the position illustrated in FIG. 18. Then the attachment trigger 9 is activated so that the wire projection 60 draws the L-shaped projection 62 towards the handle 2 of the drill 1 thereby moving the fingers 71, 72 away from each other and permitting the drill attachment 6 to be withdrawn from the wire AB. This is the position illustrated in FIG. 18 with the wound knot completed.

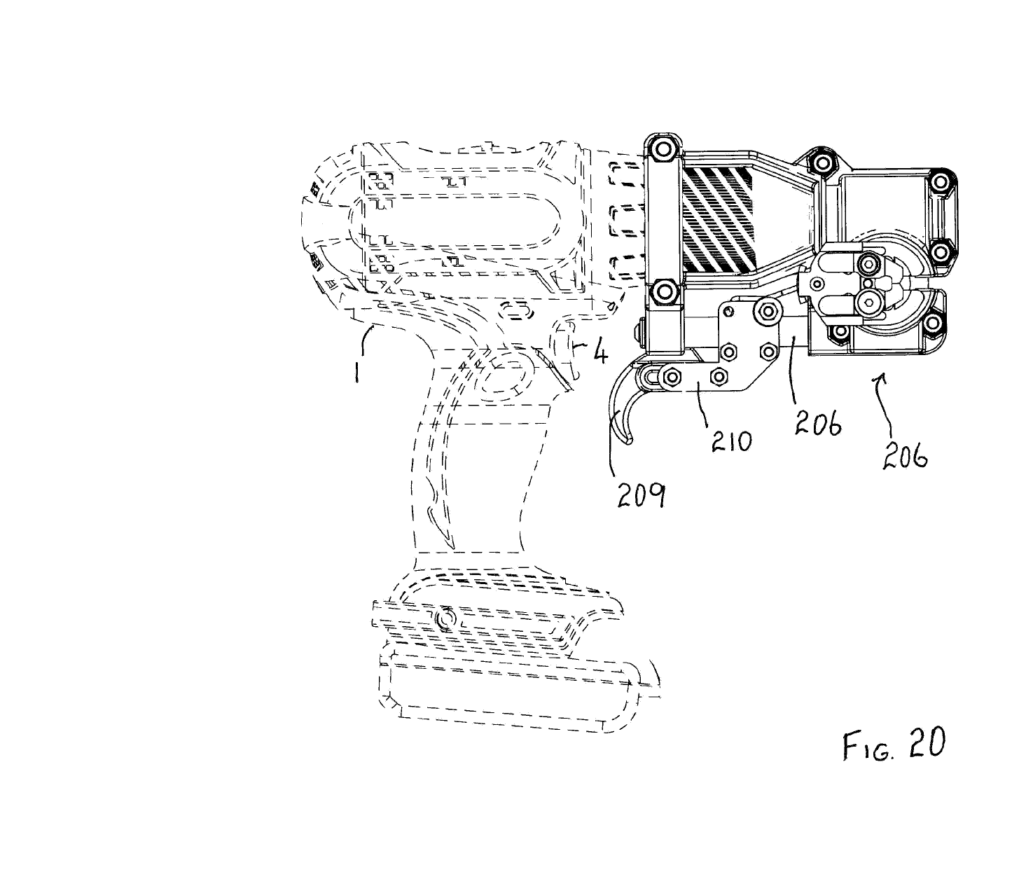

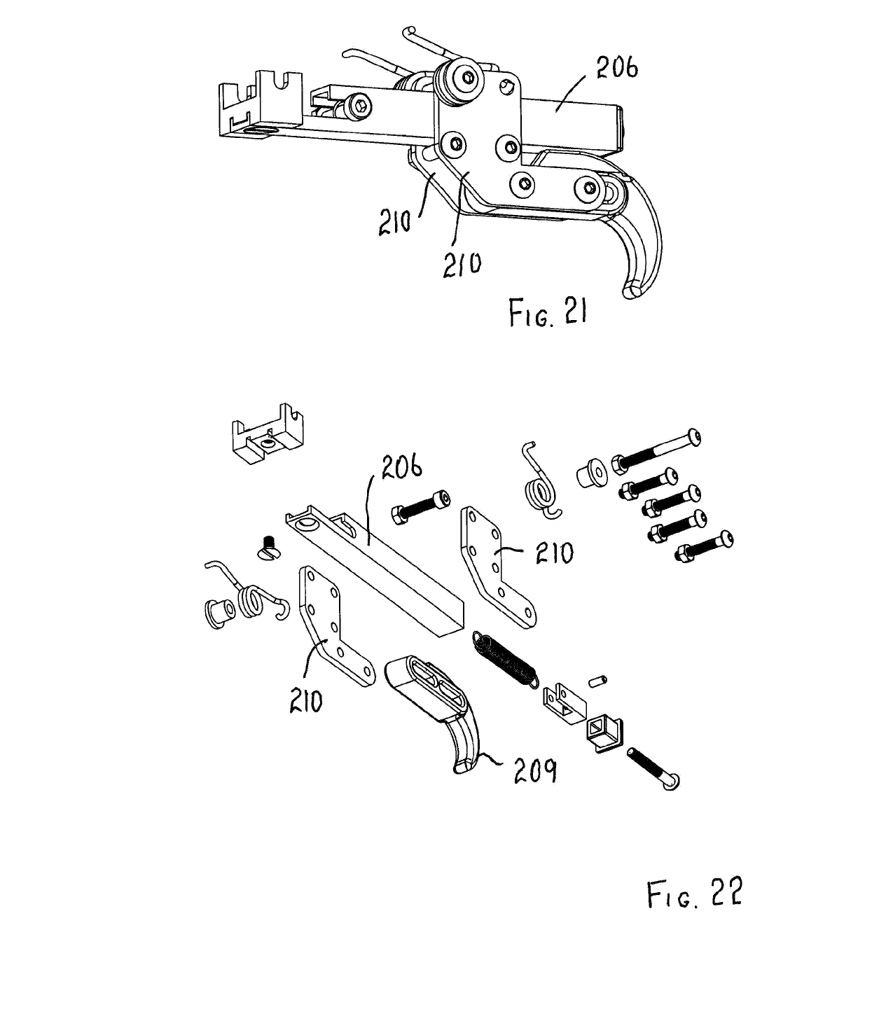

Turning now to FIGS. 19-22, a drill attachment 206 of a third embodiment is illustrated in which the trigger tube 46 of FIG. 12, for example, is modified so that the trigger tube 246 has a substantially rectangular transverse cross-sectional shape. 2L-shaped attachment plates 210 are located one to either side of the trigger tube 246 and clamp thereto in an arrangement which enables the position of the attachment plates 210 to be set either further forward or further rearwardly along the trigger tube 206. As before, the attachment trigger 209 is connected between the attachment plates 210 so as to be movable together with the trigger tube 206.

A major advantage of the above arrangement is that the position of the attachment trigger 209 can be adjusted relative to the position of the drill trigger 4 thereby allowing the drill attachment 206 to be connected to a wide range of different drills.

The foregoing describes only three embodiments of the present invention and modifications, obvious to those skilled in the fencing arts, can be made thereto without departing from the scope of the present invention. For example, the features and advantages disclosed in one facet of the invention may be utilised, mutatis mutandis, in other facets of the invention.

The term “comprising” (and its grammatical variations) as used herein is used in the inclusive sense of “including” or “having” and not in the exclusive sense of “consisting only of”.

1. A wire winding fencing attachment for a handheld power tool having a power outlet, said attachment comprising:
a housing having a mouth,
an engagement means associated with said housing to permit both the housing to be engaged with the power tool and a drive input of the attachment to be rotatably coupled to the power outlet,
a geartrain extending from said drive input to a rotor having an axis of rotation, said rotor being rotatably mounted facing said mouth,
a single winding arm mounted exterior of said housing, being rotatable with said rotor, and carrying a sheave rotatably mounted on said winding arm at a location radially spaced from said axis of rotation,
wherein said winding arm is rotatably mounted relative to said housing and movable between a first position on one side of said housing and a second position on an opposite side of said housing.

2. The attachment as defined in claim 1 wherein said geartrain has a driveshaft rotatable by said handheld power tool outlet and a transverse shaft which drives rotation of said rotor, and said transverse shaft is rotatable relative to said driveshaft during movement of said winding arm between said first and second positions.

3. The attachment as defined in claim 2 wherein the position of said transverse shaft relative to said driveshaft is substantially the same in each of said winding arm positions.

4. The attachment as defined in claim 1 and including a first latch means which retains said winding arm in either said first or said second position.

5. The attachment as defined in claim 4 wherein said first latch means is movable by a release actuator attached to said housing and having a release plunger which extends beyond said housing.

6. The attachment as defined in claim 5 wherein said winding arm has a pair of opposed pivoted fingers constituting a latching support rest for said first wire and located closely adjacent said sheave.

7. The attachment as defined in claim 6 wherein said fingers are resiliently mounted, are biased towards a closed configuration in which the tips of said fingers contact each other to form a second latch, and are movable by said release actuator to release said second latch and permit said first wire to move out of said mouth.

8. The attachment as defined in claim 1 wherein a resiliently mounted projection interconnects said winding arm and an actuating mechanism including an actuating trigger whereby movement of said actuating trigger moves said winding arm into a wire receiving configuration.

9. The attachment as defined in claim 8 wherein said resiliently mounted projection is spring-loaded whereby releasing said actuating trigger move said winding arm out of said wire receiving configuration and into a wire holding configuration.

10. The attachment as defined in claim 9 wherein with said actuating mechanism not actuated, said winding arm is rotatable without engaging said resiliently mounted projection.
